(19) United States
(12) Patent Application Publication
(10) Pub. No.: US 2021/0162577 A1
(43) Pub. Date: Jun. 3, 2021

(54) DISHWAND SUPPORT WITH HOOKING WRAP-AROUND ATTACHMENT

(71) Applicant: 3M INNOVATIVE PROPERTIES COMPANY, St. Paul, MN (US)

(72) Inventors: Megan E. Renner, San Francisco, CA (US); Matthew D. Chaffee, Minneapolis, MN (US); Michael C. Mooney, Coon Rapids, MN (US); Heidi A. Sandell, St. Paul, MN (US); Mark W. Baldwin, Woodbury, MN (US)

(21) Appl. No.: 16/636,272

(22) PCT Filed: Aug. 6, 2018
(86) PCT No.: PCT/IB2018/055915

§ 371 Date: Feb. 3, 2020

Related U.S. Application Data
(60) Provisional application No. 62/544,426, filed on Aug. 11, 2017.

(51) Int. Cl. B25G 3/18; A47L 17/04; A47L 13/16

(52) U.S. Cl. CPC B25G 3/18; A47L 13/16; A47L 17/04

(57) ABSTRACT

The present invention is a support for a handle. The support includes a first end, a second end opposite the first end, a top surface, a bottom surface, a tab extending from the second end, and a stop at the second end.

### FIELD OF THE INVENTION

The present invention relates generally to the field of cleaning tools. In particular, the present invention relates to a dishwand support having a curved cleaning section.

### BACKGROUND

Cleaning tools are commonly used for cleaning dishes, bathrooms, walls, fabric, and showers. These cleaning tools can have various types of cleaning heads for different types of cleaning tasks. Depending on the cleaning task, the cleaning head can be made of various materials, such as foam, sponge, fabric, bristles, and scrubbing webs. In some cases, the cleaning heads may be attached to a solid or semi-flexible handled tool. Cleaning chemicals, solutions, or mixtures, such as dishwash detergents or general purpose cleaners, are often used in combination with the cleaning tools to aid in the cleaning process. Some cleaning tools include a chamber for holding solid or liquid cleaning mixtures that can be dispensed onto the surface to be cleaned or directly into the cleaning head. The cleaning solution contained within the dishwand can be conveniently applied to the surface to be cleaned through the working head of the dishwand. The dishwands can be very useful for cleaning flat or slightly curved surfaces, such as plates, counters, and tiled surfaces, as well as cleaning curved surfaces, such as small bowls or cups, tubs, and sinks.

The cleaning head is oftentimes attached to the handle by a support or “shoe” and is designed to easily attach to, and detach from, the handle. The cleaning or scrubbing substrate is attached to the support and can be any combination of materials. Some handheld cleaning tools may have bristles for cleaning while some may have a foam head that might also have scouring abilities. Cleaning substrates come in many shapes, including variations on flat and curved (3D) embodiments. Having a curved tip on the cleaning tool provides users a method for cleaning tight corners and curves, as well as offering a greater range of holding angle to make sufficient contact with the cleaning surface. By using a support that is easily removable from the handle, the user's cleaning experience can be improved by making it easier and faster for users to exchange a worn cleaning head for a new cleaning head.

### SUMMARY

In one embodiment, the present invention is a support for a handle. The support includes a first end, a second end opposite the first end, a top surface, a bottom surface, a tab extending from the second end, and a stop at the second end.

In another embodiment, the present invention is a cleaning head for a dishwand. The cleaning head includes a support and a cleaning material. The support has a first end, a second end, a top surface, a bottom surface, a tab extending from the second end, and a stop. The cleaning material has a tab slit for engagement with the tab of the support. The cleaning material wraps around the second end of the support.

In yet another embodiment, the present invention is a method of assembling a cleaning head. The method includes inserting a tab of a support into a tab slit of a cleaning material; engaging the tab slit of the cleaning material with a stop of a support; wrapping the cleaning material over an end of the support; and attaching the cleaning material to a bottom surface of the support.

In yet another embodiment, the present invention is a method of assembling a cleaning head. The method includes attaching a cleaning material to a bottom surface of a support, ensuring an accurately-placed attachment; wrapping the cleaning material over an end of the support; inserting a tab of the support into a tab slit of a cleaning material; and engaging the tab slit of the cleaning material with a stop of the support.

### BRIEF DESCRIPTION OF THE DRAWINGS

FIG. 1 is a perspective view of a cleaning tool having a cleaning head attached to a handle using a support of the present invention.

FIG. 2A is a perspective view of a first embodiment of the support of the present invention.

FIG. 2B is a top view of the first embodiment of the support of the present invention.

FIG. 2C is a side view of the first embodiment of the support of the present invention.

FIG. 3 is a side view of a second embodiment of a second end of the support of the present invention.

FIG. 4 is a side view of a cleaning tool having a cleaning head attached to a handle using a support of the present invention.

FIG. 5A is a perspective view of a first embodiment of a stop at the second end of the support of the present invention.

FIG. 5B is a perspective view of a second embodiment of a stop at the second end of the support of the present invention.

FIG. 5C is a top view of a third embodiment of a stop at the second end of the support of the present invention.

FIG. 5D is a perspective view of the third embodiment of FIG. 5C of the stop at the second end of the support of the present invention.

FIG. 6 is a front view of a second end of the support of the present invention having a cut-out.

FIG. 7 is a top view of a second end of a cleaning head having cleaning material attached to the support of the present invention.

FIG. 8A is a top view of a cleaning material used with the support of the present invention.

FIG. 8B is a top view of the cleaning material of 8A used with the support of the present invention

FIG. 8C is a bottom view of the first step of attaching cleaning material onto the support of the present invention.

FIG. 9A is a side view of cleaning material attached to the support of the present invention, which is attached to a handle.

FIG. 9B is a top view of cleaning material attached to the support of the present invention.

While the above-identified drawings and figures set forth embodiments of the invention, other embodiments are also contemplated, as noted in the discussion. In all cases, this disclosure presents the invention by way of representation and not limitation. It should be understood that numerous other modifications and embodiments can be devised by those skilled in the art, which fall within the scope and spirit of this invention. The figures may not be drawn to scale.

### DETAILED DESCRIPTION

The present invention is a support, a cleaning head incorporating the support, and a method of assembling a cleaning head using the support. The support of the present invention is designed to provide stability and security to a cleaning material using a unique ‘wrap-around’ method which can then be attached to a cleaning tool.

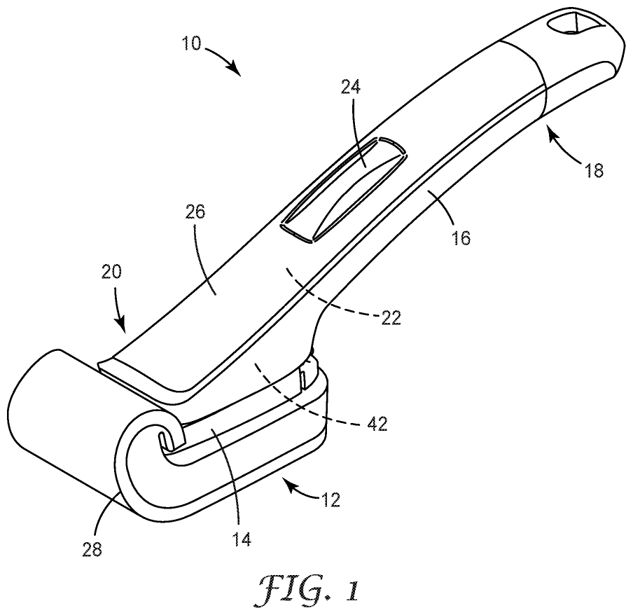

FIG. 1 is a perspective view of one embodiment of a cleaning tool 10 having a cleaning head 12 attached to the cleaning tool 10 using the support 14 of the present invention. The cleaning tool 10 includes a handle 16 with a holding end 18 and a working end 20 positioned opposite the holding end 18. The cleaning head 12 is attached to the handle 16 at the working end 20. In one embodiment, the support 14 is removably attachable to the handle 16. In another embodiment, the support 14 is permanently attached to the handle 16.

In one embodiment, the handle 16 includes a receptacle 22 (not shown) for holding a liquid, such as, for example, liquid dish soap. To aid in dispensing the dish soap from the receptacle 22 to the cleaning head 12, the handle 16 includes a passage (not shown in FIG. 1). In one embodiment, to prevent continuous dispensing of the liquid contained within the receptacle 22, the handle 16 may include a valve mechanism or pump at the passage to hold the liquid in the handle 16 until sufficient user input pressure is generated when soap is required. The pressure may come from deformation of an actuator 24. In this embodiment, the actuator 24 is deformable and is located on a topside 26 of the handle 16. However, the actuator 24 may be positioned anywhere along the handle 16. From the passage, the liquid can enter into or through the cleaning head 12. The cleaning head 12 may itself include through passages to further aid in the fast release of the dispensed liquid from the handle 16 to the surface being cleaned.

The cleaning head 12 includes the support 14 and a cleaning material 28 secured to the support 14. In use, it is the cleaning head 12 that is used to clean, wipe, or scour a surface. The cleaning material 28 of the cleaning head 12 makes contact with a surface to be cleaned and is constructed of a material suitable for cleaning. In one embodiment, the cleaning material 28 is constructed of one or more materials suitable for wiping, washing, scrubbing and/or scouring. In one embodiment, the cleaning material 28 is comprised of a synthetic or cellulose foam; a woven, knitted, or nonwoven fabric; a scouring web; bristles; or a combination of one or more of these materials.

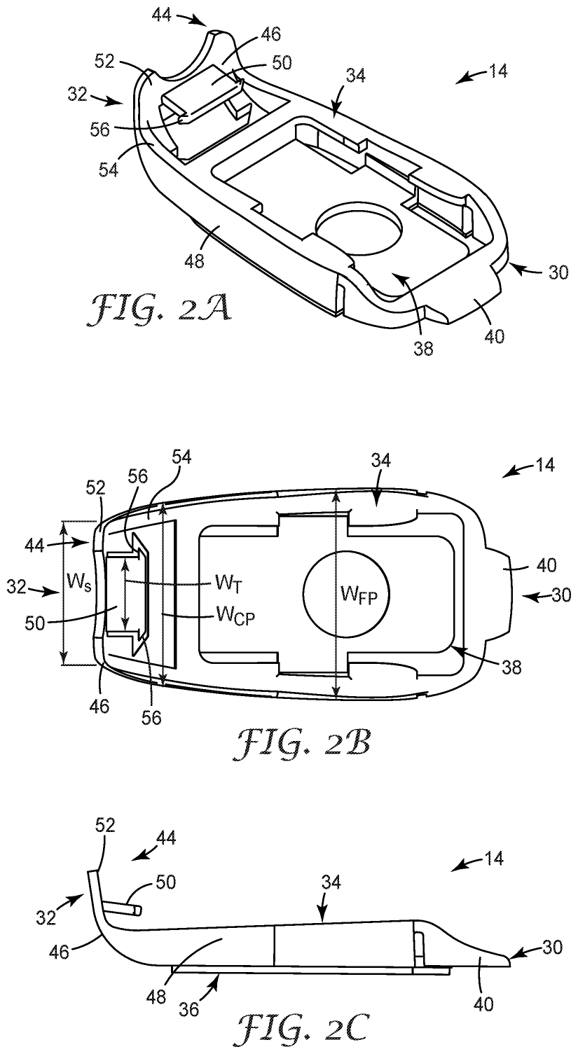

FIGS. 2A, 2B, and 2C are a perspective view, a top view, and a side view, respectively, of an embodiment of the support 14 of the present invention. Generally, the support 14 is made from a relatively rigid material so that there is secure attachment when the support 14 is attached to the handle 16 (shown in FIG. 1). In one embodiment, the support 14 is made from plastic. The support 14 generally includes a first end 30, a second end 32, a top surface 34 and a bottom surface 36. The first end 30 is generally used to attach the support 14 to the handle 16 while the second end 32 provides structure, strength and a level of semi-rigidity to the cleaning material 28.

In the embodiment shown in FIGS. 2A-2C, the first end 30 of the support 14 includes a slot 38 for receiving the handle 16 and a latch 40. The working end 20 of the handle 16 includes a connector 42 (not shown) for sliding into the slot 38 of the support 14. The latch 40 of the support 14 is deformable to allow for the connector 42 of the handle 16 to slide in and out of the slot 38 of the support 14. When the latch 40 is in place, it securely wraps around the entire backside of the working end 20 of the handle 16 to provide a secure connection between the support 14 and the handle 16. While FIGS. 2A, 2B, and 2C depict a particular method of attaching the support 14 to the handle 16, any method of attachment may be used without departing from the intended scope of the present invention.

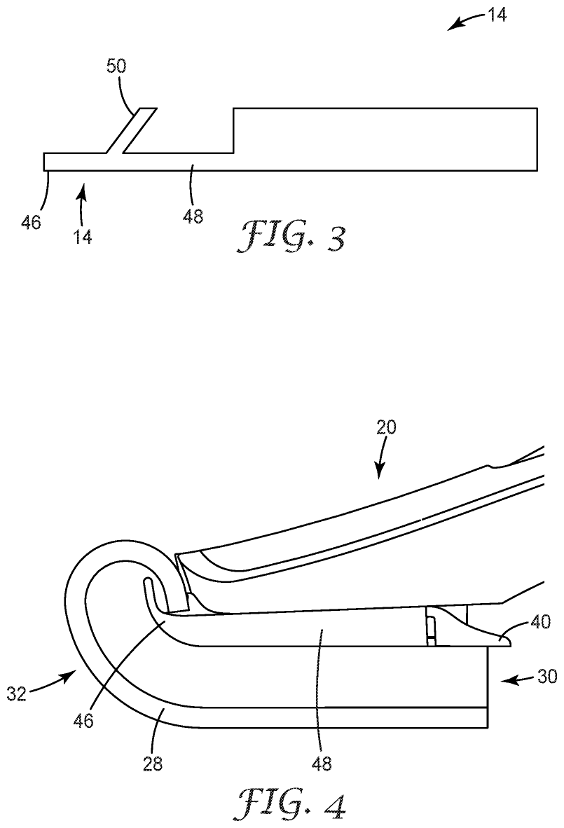

The second end 32 of the support 14 includes a front portion 44 including a curved portion 46 and a flat portion 48. The second end 32 generally includes a tab 50, a stop 52, and a pair of ribs 54. The curved portion 46 of the second end 32 of the support 14 is angled to create a curved shape, or the front curve, for cleaning. The curved portion 46 may have as little as no curvature and lie flat, as shown in an embodiment of the support shown in FIG. 3, or stand vertically. In one embodiment, the curved portion 46 of the second end 32 is angled upwards away from the bottom surface 36 of the support 14 (or towards the top surface 34 of the support 14), and can curve up to and 270 degrees relative to the bottom surface 36 of the support 14, and particularly about 9 degrees, from the vertical and can be any height depending on the cleaning task. In one embodiment, the curved portion 46 is about 20 mm vertically tall. Generally, the width W_{FP} of the flat portion 48 of the first end 30 is equal to or greater than the width W_{CP} of the curved portion 46 of the second end 32. In one embodiment, the shape/width of the front portion 44 and curved portion 46 is no wider than a maximum width of the support 14, W_{CP} is less than W_{FP}. The width W_{CP} of the curved portion 46 is related to the width W_{T} of the tab 50, which extends from the second end 32 of the support 14 and aids in maintaining the cleaning material in place. The curved portion 46 of the second end 32 assists in creating the curve of the cleaning material 28 shown in FIG. 4 when the cleaning material 28 is attached to the support 14. The curve of the cleaning material 28 allows for users of the dishwand to reach into corners and curved surfaces in dishware, scrub in non-traditional locations, and scrub multiple surfaces at once (i.e. horizontal and vertical simultaneously).

The tab 50 allows the cleaning material 28 to be mechanically fastened to the support 14. The mechanical fastening provides a superior method of fastening compared to traditional methods of attaching the cleaning material 28 to the support 14, such as using heat or chemical fusing, or using an adhesive. The tab 50 extends from the top surface 34 of the second end 32 of the support 14 in the general direction of the first end 30 of the support 14.

The tab 50 can protrude from anywhere along the second end 32. In one embodiment, the tab 50 extends from the curved portion 46 of the second end 32. The location of the tab 50 can vary depending on parameters related to the cleaning material 28, including, but not limited to: the material properties, composition, thickness, manufacturing restrictions, and materials cost. In addition, other considerations for the position of the tab 50 includes optimization for the assembly of the cleaning material 28 onto the bottom surface 36 onto the support 14, as well as minimizing the amount of the cleaning material 28 being used. Generally, given the same height of the curved portion 46, the closer the tab 50 is to the flat portion 48 of the support 14, the more cleaning material 28 is needed to wrap further down the curved portion 46 of the second end 32. Generally, the cleaning material 28 must be long enough to fully cover the first end 30 of the support 14 or the flat portion 48 of the support 14 and wrap around the end of the curved portion 46 and extend down beyond the tab 50. In one embodiment, the tab 50 can be positioned along the curved portion 46 as low as about 3 mm from the flat, top surface 34 of the support 14 to a maximum height equal to the height of the curved portion 46 or flush with the end of the top surface 34 of the second end 32 of the support 14, and particularly about 13 mm above the flat, top surface 34 of the support 14, allowing for a sufficient amount of cleaning material 28 to be looped around the tab 50.

In one embodiment, the tab 50 is angled downward from the top surface 34 of the curved portion 46 toward the top surface 34 of the flat portion 48 of the support 14 in order to assist in holding the cleaning material 28 in place when the cleaning material 28 is positioned on the support 14. Depending on the geometry of the tab 50, the tab angle with respect to the top surface 34 of the second end 32 can range from being parallel or an extension of the top surface 34 from the curved portion 46 to looping/bending back a complete 180 degrees from the top surface 34 of the curved portion 46. The angle and shape of the tab 50 will vary for different applications and attachments of cleaning materials. For example, the tab may be straight or curved. Optimizing the angle of the tab can also reduce the size of an undesirable protrusion that can be formed by the cleaning material when attached to the support, as is discussed below. In one embodiment, the tab 50 is angled from about 5 degrees offset from the surface of the curved portion 46, swinging down past horizontal to about 175 degrees from that same surface. In one embodiment, the tab 50 is angled downwards about 7 degrees from horizontal.

The width W_{T} of the tab 50 affects the curved design of the second end 32 of the support 14. The maximum width W_{T} of the tab 50 is defined as being equal to the overall width of the support 14 when paired with the stop 52. While the minimum width of the tab can be infinitely small, the functionality of the tab depends on maximizing the width. In one embodiment, the width is maximized to reduce the size of the undesirable protrusion that can be created by the cleaning material. The width W_{T} of the tab 50 is correlated to the size of the resulting protrusion, as the size of the resulting protrusion is proportional to the width of the tab. The effect of the width W_{T} of the tab 50 on the undesirable protrusion can vary depending on the composition of cleaning material, i.e. thickness, material, density, but generally, as the width of the tab 50 increases, the protrusion decreases. For example, in one embodiment, a tab width W_{T} of about 10 mm created a visually undesirable protrusion, while increasing the tab width W_{T} to about 18 mm contributed to minimizing the effect of the resulting protrusion.

The length of the tab 50 is defined as the perpendicular distance the tab 50 extends from the top surface 34. In one embodiment, the length of the tab 50 is a minimum length that correlates to the length and compressibility of the cleaning material 28, in order to securely hold the cleaning material 28. In one embodiment, the length of the tab 50 is at least about 3 mm and is particularly about 10 mm when the cleaning material 28 is about 25 mm thick and has high compressibility. When compressed by an external force, the thickness of the compressed cleaning material should be equal to or less than the length of the tab. This ensures that the cleaning material is held securely in place by the wrap-around forces.

Optionally, the tab 50 may include prongs 56 as a secondary measure to ensure the security of the cleaning material 28 around the tab 50 and to the support 14. While the force of the wrap-around of the cleaning material 28 around the support 14 is generally enough to secure the cleaning material 28, the prongs 56 can be incorporated as an additional measure to aid holding the cleaning material 28 in place and preventing it from backing out over the tab 50 when the cleaning material 28 is assembled or compressed below/beyond/over the prongs 56. The prongs 56 may be located on either the tab 50 or the curved portion 46, and any number of prongs may be included without departing from the intended scope of the present invention. In one embodiment, the tab 50 includes two prongs 56 on either side of the tab 50. The prongs 56 can be any size and may take any shape or configuration that can act to secure the cleaning material without departing from the intended scope of the present invention. In the embodiment shown in FIGS. 2A and 2B, the prongs are 2 mm×2 mm triangles.

The stop 52 is a feature or method of maintaining the curvature of the cleaning material 28 when attached to the support 14. The stop 52 can take multiple forms and provides optimized functionality of the curved portion 46 of the support 14. The stop 52 has width W_{S} that is equal to or greater than a width of the tab W_{T}. In one embodiment, the stop 52 can be formed from the second end itself or can be formed from an additional element added to the second end 32 to hold the cleaning material 28 in its curved position. The support 14 requires the stop 52 paired with the tab 50 to hold the cleaning material 28 in a secure curved position.

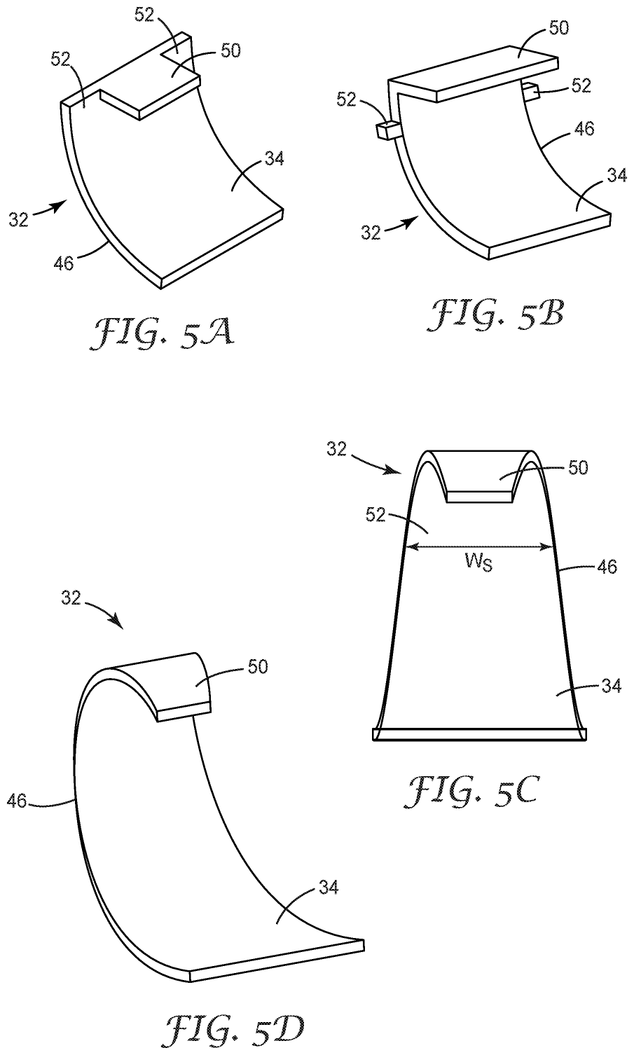

Multiple embodiments of suitable stops are shown without limitation in FIGS. 5A-5D. For example, FIGS. 5C and 5D depict top and perspective views, respectively, of a method where the tab 50 simply widens continuously to the width of the support 14. This widening can act as a stop, as the width of a tab slit in the cleaning material will slide down this design until the tab slit tightens around the curved portion which acts as the stop at a location where the widths of the tab slit and the second end are equal.

To help maintain the curvature and shape of the support 14 and cleaning material 28 in-use and over time, optional ribs 54 can be added at the base of the curved portion 46 as structural support features. The ribs 54 help prevent the front curve and overall curvature of the second end 32 from bending beyond material limitations in use and breaking when the cleaning material 28 is assembled onto the support 14. In the embodiment shown in FIGS. 2A, 2B, and 2C, the support 14 includes two ribs 54 that run flush with the side edges of the support 14; however, the support 14 can include any number of ribs without departing from the intended scope of the present invention. In one embodiment, the support 14 does not include any ribs if flexibility is desired for the intended application. Depending on the foreseen forces exerted onto the curve during cleaning, the design of the ribs can vary. If the support 14 includes more than one rib, the ribs can have different thicknesses and heights. Generally, the more or thicker the ribs, the more rigid the front curve. The fewer and/or thinner the ribs, the more flexible the front curve. In one embodiment, the ribs can have a thickness up to about half the width of the support. In one embodiment, the ribs are about 4 mm thick.

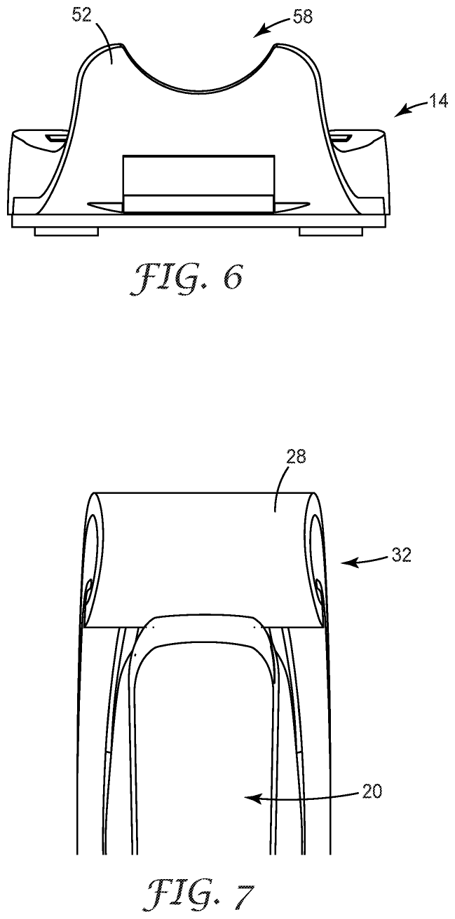

The second end 32 of the support 14 can also include a cut-out 58, as shown in FIG. 6. The cut-out 58 is designed to prevent the cleaning material 28 from protruding in an undesirable manner when the cleaning material 28 is attached to and wrapped around the second end 32 of the support 14. The cut-out 58 is sized to minimize any potential undesirable protrusion formed by the cleaning material 28 that occurs as a result of folding a compressible material and creating high forces of compression within layers when the cleaning material 28 is compressed during assembly around the tab 50 and pulled in tension as it is wrapped around the front end 32 of the support 14. When the cleaning material 28 is wrapped around the support 14, the internal compression of the cleaning material 28 makes the outside surface of the cleaning material 28 prone to forming a bulge at the tab slit 64 and across the width of the cleaning material 28. By adding the counter-active cut-out 58 where the bulge occurs, the compression of the cleaning material 28 has a greater volume to sink down into, thus creating an overall flat top appearance on the external surface, as shown in FIG. 7. In addition, having a downward angled tab will also reduce any bulge. While the cut-out 58 is shown in FIG. 6 as having a U-shape, the cut-out 58 can take any shape that minimizes any protrusion or bulge created by wrapping the cleaning material 28 around the second end 32 of the support 14 without departing from the intended scope of the present invention. In one embodiment, this cut-out 58 is as deep as the height of the tab 50 from the very end of the second end 32 and up to the maximum width of the curved portion 46. In one embodiment, the cut-out 58 is about 5.5 mm deep and about 18.75 mm wide.

In practice, a cleaning material 28 is attached to the support 14 to form the cleaning head 12 of the cleaning tool 10. The cleaning material 28 has a certain composition, thickness, and tensile strength, all which affect the unique wrap-around assembly of this system. Generally, the cleaning material 28 has a first end 60 and a second end 62 and can be any variety of shapes and thicknesses. In one embodiment, the cleaning material 28 has a thickness of at least about 1 mm. The second end 62 of the cleaning material 28 has a tab slit 64. The tab slit 64 width should not be wider than a certain size, which is related to the cleaning material's overall width at the location of the tab slit 64, and the material properties of the cleaning material 28, such as tensile strength. The width of the tab slit 64 should be limited such that it will not tear through to the edge of the cleaning material 28 when applied onto the support tab 50 or during use. In one embodiment, the tab slit 64 has a width of about 1 mm to about half the width of the cleaning material 28. In one embodiment, the tab slit 64 should not get closer than about 5 mm to the edges of the cleaning material 28, the maximum width.

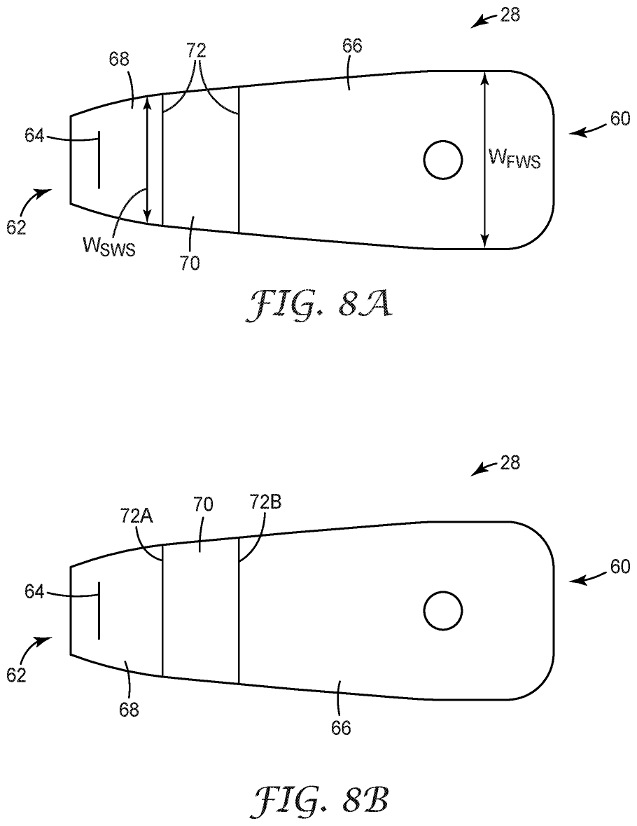

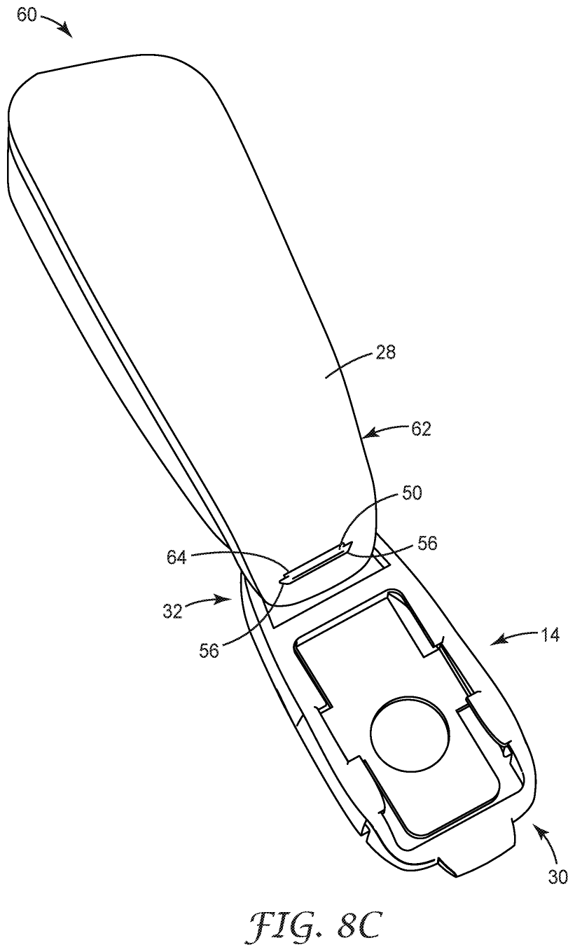

FIGS. 8A and 8B show a top and a bottom view, respectively, of an embodiment of a cleaning material used with the support of the present invention. FIG. 8C shows a bottom view of the cleaning material in a first step of attaching the cleaning material 28 onto the support tab 50 through the tab slit 64 of the cleaning material 28. Various methods can be used to mount and attach the cleaning material 28 onto the support 14. In one embodiment, the second end 62 of the cleaning material 28 is first positioned over the second end 32 of the support 14 so that the tab slit 64 of the cleaning material 28 is aligned with the tab 50 of the support 14. In this position, the first end 60 of the cleaning material 28 and the first end 30 of the support 14 extend away from each other. The cleaning material 28 is inserted over the tab 50 through the tab slit 64 in the cleaning material 28 and pushed onto the tab 50 until the entire thickness of the cleaning material 28 is pushed behind the prongs 56, or alternately, the tab 50 sticks through the slit 64 in the cleaning material 28. Although the cleaning material 28 shown and described in relation to FIGS. 8A and 8B depict a tab slit 64 that is cut through the thickness of the cleaning material 28, the tab slit 64 does not have to extend through the entire thickness of the cleaning material 28.

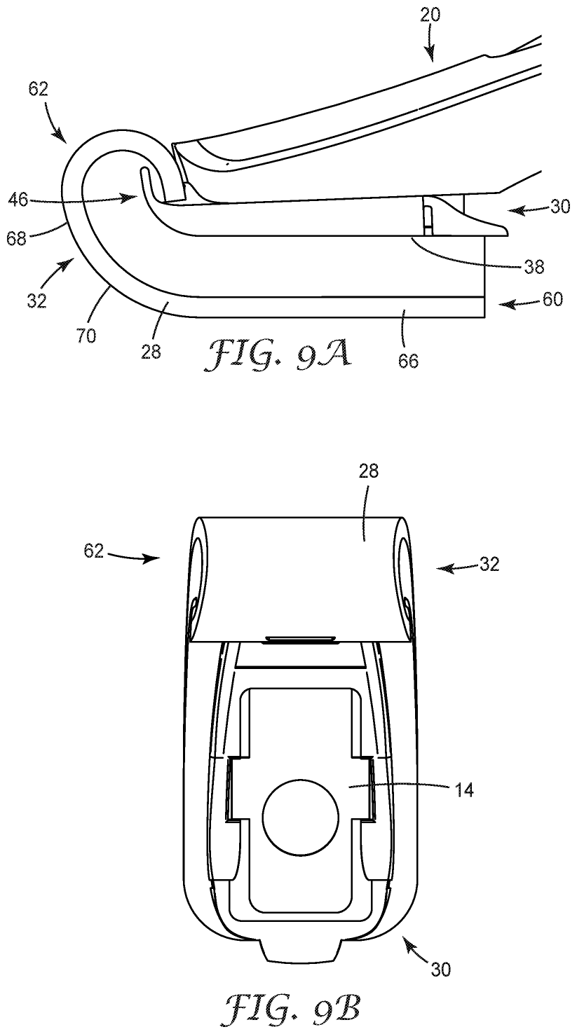

The cleaning material 28 is then wrapped over and around the second end 32 and the curved portion 46 of the support 14 and along the bottom surface 38 of the support 14, as shown in FIGS. 9A and 9B. FIG. 9A shows a side view of the cleaning material 28 attached to the support 14, which is attached to a handle 16. FIG. 9B shows a top view of the cleaning material 28 attached to the support 14. The first end 60 of the cleaning material 28 is then attached to the bottom surface 38 of the first end 30 of the support 14. The second end 62 of the cleaning material 28 is held securely in place by the design of the tab 50, prongs 56, and the stop 52 (shown in FIGS. 2A-2C) while the remainder of the cleaning material 28 may be fixed, for example by heat fusing, chemical bonding, sonic welding, or mechanical bonding to the bottom surface 38 of the support 14.

In another embodiment, the cleaning material 28 is mounted and attached onto the support 14 by attaching the first end 60 of the cleaning material 28 to the bottom surface 38 of the first end 30 of the support 14 first, and then wrapping the second end 32 of the cleaning material 28 up and around the curved portion 46 of the support 14 as the second step. The tab slit 64 of the cleaning material 28 is then pulled over the tab 50 through the slit 64 so the cleaning material 28 is compressed behind the prongs 56 and securely in place. While two methods are disclosed for mounting and attaching the cleaning material 28 onto the support 14, other methods can be used without departing from the intended scope of the present invention.

When the cleaning material 28 is assembled onto the support 14, the cleaning material 28 includes a first working surface 66 and a second working surface 68. A curving portion 70 of the second working surface 68 curves and wraps to connect with the first working surface 66. Generally, the first working surface 66 is adjacent the flat portion 48 of the support 14 and the second working surface 68 is adjacent the curved portion 46 of the support 14. In one embodiment, the cleaning material 28 continuously curves at least about 45 degrees, as measured by the angle formed through the cleaning material 28 by the first working surface 66 and second working surface 68. In one embodiment, the cleaning, material 28 continuously curves at least about 90 degrees, as measured by the angle formed through the cleaning material 28 by the first working surface 66 and second working surface 68. In one embodiment, the cleaning material 28 continuously curves less than about 180 degrees, as measured by the angle formed through the cleaning material 28 by the first working surface 66 and second working surface 68.

In one embodiment, the first working surface 66 has a width W_{FWS} and the second working surface 68 has a width W_{SWS}. In this embodiment, the width W_{FWS} is larger than the width W_{SWS}. Therefore, the curving portion 70 also has a width less than the width W_{FWS}. In one embodiment, the width W_{FWS} is at least about 10% greater than the width W_{SWS}. In one embodiment, the width W_{FWS} is at least about 23% greater than the width W_{SWS}. In one embodiment, the width W_{SWS} is is at least about 30% smaller than the width W_{FWS}.

The method of wrapping the cleaning material 28 about 270 degrees around the second end 32 of the support 14 from the initial position (FIG. 8C) to the fully assembled position (FIGS. 9A and 9B) creates internal compression of the cleaning material 28, or a springback force within the cleaning material 28 at the first and second ends 60 and 62, in which the cleaning material 28 wants to un-curl and pull from the first end 30 of the support 14. Factors that affect this force include the material properties, composition, thickness, curvature, and length of the cleaning material, as well as all of the above described key features of the curved portion 46 of the support 14. The length of the cleaning material 28 affects how tightly it must be wrapped-around the support 14 so that the entire support has cleaning material 28 along the length of the bottom surface 38 of the support 14. The shorter the cleaning material 28, the tighter it must be pulled to wrap around the curved portion 46 of the second end 32, resulting in higher spring back forces and a greater risk of the cleaning material 28 pulling away from the first end of the support 30. Thus, the longer the cleaning material 28, the less compression/tension there is around the curved portion 46. In one embodiment, a cleaning material 28 having a flat-length of between about 145 and 165 mm, and particularly about 160 mm was found to have a reduced spring back force compared to a flat-length of 140 mm, as well as provided an ample amount of material for fusing the cleaning material 28 to the support 14 during manufacturing.

If the concentration of springback force at the curved portion 46 is too high, this force can cause issues, such as delamination of the cleaning material 28 from the first end 30 of the support 14. The support design of the present invention securely holds the second end 62 of the cleaning material 28, redistributing tension at the first end 30 of the support 14 where the latch 40 is located, and where the user is typically pushing downwards. This is optimal, so that the force does not affect the curved portion 46 when in use.

As seen in FIG. 8A, tension-reducing slits 72 can also be added in the cleaning material 28 to reduce the internal springback force. By adding strategically placed slits or cuts into the cleaning material, while not cutting all the way through, tension is reduced and assembly/fusing of the cleaning material 28 to the support 14 is made easier. The strategically placed slits have the most impact when located along the curving portion 70, as this is where the majority of tension is held in the cleaning material 28. Having multiple slits helps reduce the tension, but must be balanced with maintaining the integrity of the cleaning material 28. In one embodiment, the cleaning material 28 includes two slits 72. In one embodiment, the first slit 72A is located between about 1 mm and about 50 mm, and particularly about 30 mm, from the second end 62 of the cleaning material 28 and the second slit 72B is located between about 30 mm and about 100 mm, and particularly about 70 mm, from the second end 32 of the cleaning material 28, which has an overall uncurled length of about 155 mm.

It is understood that the cleaning head 12 may be secured to a separate cleaning tool 10 which includes a handle 16 or may he independently used for cleaning. Further, if used with a cleaning tool, any variety of sizes and shapes of cleaning tools could be used and any specific types of attachment mechanisms could be used for securing the cleaning element to the cleaning tool.

The disclosed support, curved cleaning head, and method of making the cleaning head provide for a continuously curved working surface useful for cleaning both gentle and sharp curving surfaces such a bowls, cups, muffin tins, or coffee mugs, for example.

Although specific embodiments of this invention have been shown and described herein, it is understood that these embodiments are merely illustrative of the many possible specific arrangements that can be devised in application of the principles of the invention. Numerous and varied other arrangements can be devised in accordance with these principles by those of ordinary skill in the art without departing from the spirit and scope of the invention. Thus, the scope of the present invention should not be limited to the structures described in this application, but only by the structures described by the language of the claims and the equivalents of those structures.

What is claimed is:

1. A support for a handle comprising:
a first end;
a second end opposite the first end;
a top surface;
a bottom surface;
a tab extending from the second end; and
a stop at the second end.

2. The support of claim 1, further comprising at least one prong extending from the tab.

3. The support of claim 1, further comprising a rib.

4. The support of claim 1, further comprising a cut-out at the second end.

5. The support of claim 1, wherein the second end includes a front curve.

6. The support of claim 1, wherein a width of the stop is equal to or greater than a width of the tab.

7. The support of claim 1, wherein the tab extends from the second end of the support at a downward angle.

8. A cleaning head for a dishwand comprising:
a support having a first end, a second end, a top surface, a bottom surface, a tab extending from the second end, and a stop; and
cleaning material having a tab slit for engagement with the tab of the support;
wherein the cleaning material wraps around the second end of the support.

9. The cleaning head of claim 8, wherein the cleaning material further comprises a slit.

10. The cleaning head of claim 8, wherein a width of the stop is equal to or greater than a width of the tab.

11. The cleaning head of claim 8, wherein the second end of the support further comprises a front curve.

12. The cleaning head of claim 8, wherein the support further comprises a prong for engagement with the cleaning material.

13. The cleaning head of claim 8, wherein the support further comprises a cut-out at the second end.

14. The cleaning head of claim 8, wherein the support further comprises a rib.

15. A method of assembling a cleaning head, the method comprising:
inserting a tab of a support into a tab slit of a cleaning material;
engaging the tab slit of the cleaning material with a stop of a support;
wrapping the cleaning material over an end of the support; and
attaching the cleaning material to a bottom surface of the support.

16. The method of claim 15, wherein the cleaning material is attached to the bottom surface of the support by one of heat fusing, chemical bonding, sonic welding, and mechanical bonding.

17. The method of claim 15, wherein inserting the tab of the support into the tab slit of the cleaning material includes engaging a prong on the tab with the cleaning material.

18. The method of claim 15, wherein the end of the support includes a cut-out.

19. The method of claim 15, wherein the end of the support includes a front curve.

20. The method of claim 15, wherein a width of the stop is equal to or greater than a width of the tab.
